(19) United States
(12) Patent Application Publication
(10) Pub. No.: US 2019/0261642 A1
(43) Pub. Date: Aug. 29, 2019

(54) METHOD FOR MAKING A PARTIALLY COOKED CHEESE PRODUCT AND USES THEREOF

(71) Applicant: LOTITO FOODS HOLDING, LLC, EDISION, NJ (US)

(72) Inventor: Christopher L. Lotito, Edison, NJ (US)

(21) Appl. No.: 16/399,257

(22) Filed: Apr. 30, 2019

Related U.S. Application Data
(63) Continuation of application No. 15/411,216, filed on Jan. 20, 2017.
(60) Provisional application No. 62/290,685, filed on Feb. 3, 2016.
(60) Provisional application No. 62/291,145, filed on Feb. 4, 2016.
(60) Provisional application No. 62/306,917, filed on Mar. 11, 2016.

(51) Int. Cl. A23C 19/09; A23C 19/072

(52) U.S. Cl. CPC A23C 19/0912; A23C 19/072; A23C 19/0908; A23C 2250/10; A23C 2250/15; A23C 19/0925

(57) ABSTRACT

The invention relates to a method for preparing a partially cooked cheese product, as well as the partially cooked cheese product itself. The method appears applies specific times and temperatures to produce a pliable, carbohydrate free cheese product, which is free of carbohydrates. The product can be used, for example, as a carbohydrate free all cheese bread substitute in “sandwich wraps” or other applications.'

### CROSS-REFERENCE TO RELATED APPLICATIONS

This application is a continuation of U.S. Application Ser. No.: 15/411,216, filed Jan. 20, 2017; which claims the benefit of priority to U.S. Provisional Application No.: 62/290,685, filed Feb. 3, 2016; U.S. Provisional Application No.: 62/291,145, filed Feb. 4, 2016; and U.S. Provisional Application No.: 62/306,917, filed Mar. 11, 2016, all of which are incorporated by reference in their entireties.

### FIELD OF THE INVENTION

This invention relates to a method for manufacturing a partially cooked cheese product. A further feature of the invention are the partially cooked cheese products themselves, which can be used per se as, e.g., wraps, or can be further processed to form cheese crisps.

### BACKGROUND

“Cheese crisps,” “parmesan crisps,” or “frico” are a standard product used, e.g., as snacks, additives to salads or other dishes, etc. “Frico” derive from Northern Italian cooking, and are made from montasio cheese. As this cheese can be difficult to find, other varieties, especially parmesan, have been used instead, and indeed, most consumers are familiar with “parmesan crisps,” rather than frico.

The product will be referred to as a cheese crisp hereafter.

These cheese crisps can be made in various sizes. Smaller ones, e.g., less than 3 inches in diameter, exhibit greater stability, but are not as desirable for restaurant service as larger ones are. While any restaurant can make these from scratch, it will be understood that issues of space, staff, etc., often preclude this. If the product is made before service, its fragility becomes a problem, as do issues of storage. Hence, many restaurants purchase pre-made cheese crisps, but as noted supra, larger products are not generally available because of fragility.

It has now been found that a partially cooked cheese product can be prepared which is stable, i.e., avoids the fragility problem discussed supra, can be shipped to customers where the product can be finished, and is adaptable to a variety of different cheeses and mixtures of cheeses. The invention described herein permits an end user, such as a restaurant, to reduce the amount of time necessary to prepare the crisps described herein, since they are already partially cooked. Further, the process of the invention yields a product which is flexible, rather than crispy, and avoids problems caused by the fragility of the end product, e.g., crumbling. As a result, the partially cooked cheese product of the invention can also be used as a gluten-free, “all cheese” wrap product, i.e., a product which replaces a tortilla, pita, or other flat form of bread and surrounds an edible filing as, e.g., a sandwich wrap or other food product.

### DETAILED DESCRIPTION

In a preferred embodiment, one or a mixture of cheeses are first grated. Many types of cheeses require no treatment to be made “gratable,” (e.g., parmesan, pecorino, asiago, manchego, montasio, Jarlsberg, dry Jack and aged provolone) while others might benefit from pretreatment, such as short-term freezing. Exemplary of such are fontina, gouda, cheddar, comte, caciocavallo and young provolone.

The artisan of ordinary skill will recognize that some cheese varieties are simply not suitable for grating, such as ricotta, mascarpone and other cheeses which are eaten fresh, with a high concentration of liquid, rather than being aged.

Optionally, one can add flavoring materials to the grated cheese, or stabilizers, such as flour. Flavoring agents including but are not limited to, black pepper, fresh or dried herbs, dried vegetables such as tomatoes or peppers, chopped olives, and so forth. In the carbohydrate free embodiment discussed infra, ingredients such as flour are not included.

The mixture is then placed on a baking sheet or other oven-safe device, preferably coated with, e.g., Silpat®, parchment, or other material to prevent adherence to the baking sheet. For each crisp product, sufficient mixture is deposited to form a finished product about 3-10 inches, preferably, 4-8 and most preferably, 5-7 inches in diameter. The mixture does not spread much in cooking, so the amounts of mixture are not critical, as long as it is spread to form a round of desired size. “Diameter” is used to refer to the product when it is prepared as a round; however, the skilled artisan will recognize that any shape may be prepared in accordance with the invention, and “diameter” should be take to refer to the longest dimension of the product, when the product shape is not circular, such as a round.

Once the baking sheet, e.g., is filled with cheese shapes, it is subjected to pressure, placed in a preheated oven, set at a temperature of from about 300 to about 425° F., preferably 350° F. The mixture melts, loses any whey liquid along with a small portion of moisture contained therein, and forms a somewhat pliable product. This product is removed from the oven after a very short time, i.e., from about 1 to about 6, and preferably about 3 minutes, and allowed to cool to ambient temperature. On an industrial scale this is accomplished by having the baking sheet move down a conveyer belt, but on a small scale, it is a simple matter to allow the product to cool for, e.g., 3-10 minutes.

When cooled to ambient temperature, the cheese rounds can then be packaged, e.g., by separating them on smaller sheets of parchment paper, stacked one upon the other, and then sealed, e.g., in a vacuum packed, sealable plastic container, such as a bag. The products are “made to order,” i.e., they are not presented as a storable commodity such as potato chips or crackers. The products are perishable and should be refrigerated prior to use.

Instructions are provided, either in the form of an insert, or printed on the container, for how to finish the product and make it a “crisp.” Essentially, the user can bake the product at about 375° F. for about 15 minutes, use a microwave for 45-90 seconds, or pan fry them on a non-stick surface for about 1-2 minutes.

For a very short window of time, the user can shape the crisp via, e.g., molding it over a cup or other receptacle, rolling it into a tube or cone, and so forth. Larger shapes may be molded into bowls or other receptacles to hold salad, pasta, etc. Other means for shaping the final product will be known to the skilled artisan. Alternatively, as noted supra, the flexible partially cooked products can be used as “wraps” in place of any other product which would be used to enclose other food products, such as tortillas, fresh pasta (e.g., for stuffed pasta), pita bread, crepes and so forth. As the cheeses used in the invention are known to be carbohydrate free (as defined by the USDA), the flexible cheese product can serve as a high protein, carbohydrate free alternative.

The terms and expression which have been employed are used as terms of description and not of limitation, and there is no intention in the use of such terms and expression of excluding any equivalents of the features shown and described or portions thereof, it being recognized that various modifications are possible within the scope of the invention.

1. An edible food product, the edible food product being formed of grated cheese that is partially melted to form an interconnected flexible and pliable integrated cheese product at ambient temperature.

2. The edible food product of claim 1 that is thin compared to its length or width.

3. The edible food product of claim 2 that is flat.

4. The edible food product of claim 1 formed into a shape having a length of from about 3 to about 10 inches at its greatest linear dimension.

5. The edible food product of claim 4 formed into a disc shape.

6. The edible food product of claim 1 formed from at least one of the group consisting of parmesan cheese, cheddar cheese, Jarlsberg cheese and combinations thereof.

7. The edible food product of claim 6 formed essentially of parmesan cheese.

8. The edible food product of claim 1 free from any flour.

9. The edible food product of claim 1, further comprising at least one of the group consisting of black pepper, vegetables, herbs, and combinations thereof.

10. The edible food product of claim 1 consisting essentially of cheese.

11. The edible food product of claim 1 comprising flour.

12. An edible food product comprising a substrate formed of interconnected partially melted pieces of cheese, wherein the substrate is an integrated structure that is flexible and pliable, and thin compared to its length or width.

13. The edible food product of claim 12, wherein the substrate is disc shaped, flat, and is capable of being rolled without crumbling.

14. The edible food product of claim 13, wherein the substrate is formed essentially of cheese.

15. The edible food product of claim 13, wherein the substrate is free from flour.

16. The edible food product of claim 15, wherein the substrate is formed from at least one of the group consisting of parmesan cheese, cheddar cheese, Jarlsberg cheese, pecorino cheese, asiago cheese, manchego cheese, montasio cheese, jack cheese, provolone cheese, gouda cheese, and combinations thereof.

17. The edible food product of claim 16, further comprising at least one of the group consisting of black pepper, flour, vegetables, herbs, and combinations thereof.

18. An edible food product prepared by a process comprising the steps of:
(a) providing a quantity of one or more pieces of cheese;
(b) spreading the quantity of one or more pieces of cheese out to form a thin substrate of overlapping cheese pieces;
(c) baking said thin substrate of overlapping cheese pieces at a temperature above ambient for a period of time to partially melt said thin substrate of overlapping cheese pieces into a thin layer of partially-melted integrated cheese product; and
(d) cooling said thin layer of partially melted integrated cheese product after baking to form a flexible and pliable edible food product.

19. The edible food product of claim 18, further comprising baking said thin substrate of overlapping cheese pieces at a temperature from about 300 degrees F. to about 425 degrees F. for a period of about 1 to about 6 minutes.

20. The edible food product of claim 19, wherein baking said thin substrate of overlapping cheese pieces is performed at a temperature of about 350 degrees F. to about 375 degrees F. for a period of about 3 minutes.

21. The edible food product of claim 18, further comprising cooling said thin layer of partially-melted, integrated cheese product to ambient temperature.

22. The edible food product of claim 21, wherein cooling said thin layer of partially melted integrated cheese product includes permitting said thin layer of partially-melted, integrated cheese product to cool by removing said thin layer of partially-melted, integrated cheese product from the temperature above ambient temperature for a period of time.

23. The edible food product of claim 18, further comprising grating one or more types of cheeses to form one or more pieces of cheese.

24. The edible food product of claim 18, wherein the thin substrate of overlapping cheese pieces consists essentially of cheese.

25. The edible food product of claim 18, wherein the thin substrate of overlapping cheese pieces is free from flour.

26. The edible food product of claim 18, further comprising spreading the one or more pieces of cheese into the thin substrate having a length of about 3 to about 10 inches at its greatest linear dimension.

27. The edible food product of claim 18, wherein the thin substrate of overlapping cheese pieces is formed of at least one of the group consisting of parmesan cheese, cheddar cheese, Jarlsberg cheese and combinations thereof.

28. The edible food product of claim 18, further comprising packaging said flexible and pliable edible food product.

29. The edible food product of claim 18, further comprising subjecting said flexible and pliable food product to additional cooking for a period of time to form a crispy cheese product that is subject to crumbling, wherein subjecting said flexible and pliable food product to additional cooking for a period of time includes at least one of the group consisting of baking at a temperature above ambient temperature, microwaving, frying, and combinations thereof.

30. The edible food product of claim 18, wherein the thin substrate of overlapping cheese pieces is baked while on a substrate moving through an oven.
